(19) United States
(12) Patent Application Publication
(10) Pub. No.: US 2026/0237652 A1
(43) Pub. Date: Aug. 13, 2026

(54) POSITIVE ELECTRODE ACTIVE MATERIAL FOR NONAQUEOUS ELECTROLYTE SECONDARY BATTERY, AND NONAQUEOUS ELECTROLYTE SECONDARY BATTERY

(71) Applicant: BASF SE, Ludwigshafen am Rhein (DE)

(72) Inventors: Zhenji HAN, Sanyoonoda (JP); Jumpei NAKAYAMA, Sanyoonoda (JP); Daisuke MORITA, Sanyoonoda (JP); Masatoshi MATSUMOTO, Sanyoonoda (JP); Kazumichi KOGA, Sanyoonoda (JP); Kazutoshi MATSUMOTO, Sanyoonoda (JP)

(21) Appl. No.: 19/149,767

(22) PCT Filed: Feb. 1, 2024
(86) PCT No.: PCT/EP24/52528

§ 371 Date: Jul. 21, 2025

(30) Foreign Application Priority Data
Feb. 1, 2023 (JP) 2023-014158

(51) Int. Cl. H01M 4/525; C01G 53/506

(52) U.S. Cl. CPC H01M 4/525; C01G 53/506; C01P 2002/50; C01P 2002/88; C01P 2004/03; C01P 2004/52; C01P 2004/53; C01P 2004/61; C01P 2006/40

(57) ABSTRACT

Disclosed herein are a positive electrode active material, a method of using the positive electrode active material, the method including using the positive electrode active material for inhibiting thermal runaway in a nonaqueous electrolyte secondary battery, and a nonaqueous electrolyte secondary battery employing this positive electrode active material.

### TECHNICAL FIELD

The present disclosure relates to a positive electrode active material for a nonaqueous electrolyte secondary battery, to the use thereof to control the oxygen release from the positive electrode active material and/or to inhibit or avoid thermal runaway in a nonaqueous electrolyte secondary battery, and to a nonaqueous electrolyte secondary battery comprising said material.

### BACKGROUND ART

Lithium ion secondary batteries have advantages of being compact and lightweight with a high energy density while also having a high charge/discharge voltage and a large charge/discharge capacity, and are therefore of interest as power sources for driving AV equipment and electronic devices such as personal computers.

Organic solvents which are mainly combustible are normally used as the electrolytic solution in lithium ion secondary batteries, so there is a need for high thermal stability. For example, oxygen is released from within positive electrode active material crystals as a result of the heat provided when a lithium ion secondary battery is in a state of charge, but the reaction of this oxygen with the electrolytic solution is known to cause thermal runaway.

Active materials comprising Ni, Co and Mn in particular have come to be widely used in recent years as positive electrode active materials. When this kind of positive electrode active material has a higher Ni content, a phase transition reaction of the positive electrode active material occurs in a lower temperature region, causing a sudden release of oxygen, which therefore makes thermal runaway likely to occur in the positive electrode active material. At the same time, there is a demand for materials having a high Ni content because of the large battery capacity, and this has consequently led to a tendency of reduced thermal stability, which is a characteristic of materials having a high Ni content.

In order to inhibit thermal runaway in this kind of positive electrode active material, Patent Document 1, for example, proposes a positive electrode active material comprising a lithium-transition metal composite oxide containing 80 mol % or greater Ni and 0.1 mol %-1.5 mol& B, with respect to the total number of moles of metal elements excluding Li, wherein B and at least one element (M1) selected from groups 4-6 are present on particle surfaces of the lithium-transition metal composite oxide, and a molar fraction of M1, with respect to the total number of moles of metal elements excluding Li, on surfaces of particles smaller than 30% particle size is greater than a molar fraction of M1, with respect to the total number of moles of metal elements excluding Li, on surfaces of particles for which the volume-based particle size is greater than 70% particle size. Patent Document 1 then indicates that using this kind of composite oxide in a lithium ion secondary battery limits a rate of self-heating, even at a high temperature.

### PRIOR ART DOCUMENTS

[Patent Document 1] JP 2021-51979 A

### SUMMARY OF THE INVENTION

### Problems to be Solved by the Invention

However, although a certain effect of inhibiting thermal runaway caused by the reaction between oxygen released from the positive electrode active material and the electrolyte may be anticipated with the positive electrode active material of Patent Document 1 because of the particle surfaces of the positive electrode active material being covered with a boron compound, this alone does not have a sufficient effect of inhibiting thermal runaway, and there is still room for improvement.

Accordingly, there is a need for a method of inhibiting thermal runaway, other than a method such as described above in which the surfaces of the positive electrode active material are covered with a compound.

The present disclosure has been devised in light of the situation described above, and the objective thereof lies in providing a positive electrode active material capable of inhibiting thermal runaway in a nonaqueous electrolyte secondary battery, and a nonaqueous electrolyte secondary battery employing this positive electrode active material.

### Means for Solving the Problems

The present inventors carried out careful investigations in order to solve the problems above. As a result of these investigations, the present inventors arrived at a positive electrode active material in which, when a volume-based particle size frequency distribution of primary particles of a composite oxide containing at least lithium and a transition metal is separated into a plurality of peaks, these peaks include specific peaks comprising: a main peak exhibiting a maximum value of peak area, and at least one peak having an area of 0.1-1, in terms of area ratio, with respect to the area of the main peak, and ratios of primary particle size (large particle size/small particle size) at peak tops of adjacent specific peaks are all 1.2-8, and it was found that when such a positive electrode active material is used in a nonaqueous electrolyte secondary battery, a maximum release rate of oxygen (referred to below as “maximum oxygen release rate”) from the positive electrode active material can be limited, and thermal runaway can also be inhibited. Specifically, the present disclosure provides the following features.

(1) In a first aspect, the present invention relates to the use of a positive electrode active material for a nonaqueous electrolyte secondary battery, the positive electrode active material comprising a composite oxide that contains at least lithium, a transition metal, and oxygen, wherein, a volume-based particle size when primary particles of the frequency distribution of composite oxide is separated into a plurality of peaks, these peaks include specific peaks comprising: a main peak exhibiting a maximum value of peak area, and at least one peak having an area of 0.1-1, in terms of area ratio, with respect to the area of the main peak, and ratios of primary particle size (large particle size/small particle size) at peak tops of adjacent specific peaks are all 1.2-8;
to inhibit or avoid thermal runaway in a nonaqueous electrolyte secondary battery.

(2) In a second aspect, the present invention relates to the use of a positive electrode active material for a nonaqueous electrolyte secondary battery, the positive electrode active material comprising a composite oxide that contains at least lithium, a transition metal, and oxygen, wherein, when a volume-based particle size frequency distribution of primary particles of the composite oxide is separated into a plurality of peaks, these peaks include specific peaks comprising: a main peak exhibiting a maximum value of peak area, and at least one peak having an area of 0.1-1, in terms of area ratio, with respect to the area of the main peak, and ratios of primary particle size (large particle size/small particle size) at peak tops of adjacent specific peaks are all 1.2-8;
to control the oxygen release from the positive electrode active material.

(3) In a third aspect, the present invention relates to a positive electrode active material for a nonaqueous electrolyte secondary battery, the positive electrode active material comprising a composite oxide that contains at least lithium, a transition metal, and oxygen, wherein, when a volume-based particle size frequency distribution of primary particles of the composite oxide is separated into a plurality of peaks, these peaks include specific peaks comprising: a main peak exhibiting a maximum value of peak area, and at least one peak having an area of 0.1-1, in terms of area ratio, with respect to the area of the main peak, and ratios of primary particle size (large particle size/small particle size) at peak tops of adjacent specific peaks are all 1.2-8.

The composite oxide is preferably a lithium-nickel composite oxide. More preferably, the composite oxide is a lithium-nickel composite oxide which has a layered rock-salt structure and is represented by the general formula LiₐNi_{1-b-c}Mn_{b}M_{c}O₂ (in the formula, M is at least one element other than Li, Ni, Mn and O, 0.95≤a≤1.15, and 0≤b+c≤0.70).

In the positive electrode active material for a nonaqueous electrolyte secondary battery as disclosed in (1) or (2) or (3) above or in the preferred embodiments below, preferably the primary particle sizes at peak tops of the specific peaks are all 80 nm-15 μm.

(4) In a fourth aspect, the present invention relates to a nonaqueous electrolyte secondary battery comprising a positive electrode containing the positive electrode active material as disclosed in (3) or in the above or below preferred embodiments thereof.

### Effects of the Invention

According to the present disclosure, the particle size of primary particles present in a positive electrode active material is controlled, which thereby makes it possible to provide a positive electrode active material capable of inhibiting thermal runaway, and a nonaqueous electrolyte secondary battery employing the positive electrode active material.

### BRIEF DESCRIPTION OF THE DRAWINGS

FIG. 1A is an example of a scanning electron microscope photograph of a composite oxide.

FIG. 1B is a diagram in which primary particles are enclosed by broken lines in the scanning electron microscope photograph of the composite oxide of FIG. 1A.

FIG. 2 is a volume-based particle size frequency distribution chart of the primary particles in a positive electrode active material sample according to example 1.

FIG. 3 is a DTG (differential thermogravimetry) curve of the positive electrode active material sample according to example 1.

FIG. 4 is a volume-based particle size frequency distribution chart of the primary particles in a positive electrode active material sample according to example 2.

FIG. 5 is a DTG curve of the positive electrode active material sample according to example 2.

FIG. 6 is a volume-based particle size frequency distribution chart of the primary particles in a positive electrode active material sample according to example 3.

FIG. 7 is a DTG curve of the positive electrode active material sample according to example 3.

FIG. 8 is a volume-based particle size frequency distribution chart of the primary particles in a positive electrode active material sample according to example 4.

FIG. 9 is a DTG curve of the positive electrode active material sample according to example 4.

FIG. 10 is a volume-based particle size frequency distribution chart of the primary particles in a positive electrode active material sample according to comparative example 1.

FIG. 11 is a DTG curve of the positive electrode active material sample according to comparative example 1.

### DETAILED DESCRIPTION OF THE INVENTION

### Embodiments of the Invention

Embodiments of the present disclosure will be described below, but the present disclosure is in no way limited by the description of the embodiments and it may be implemented with suitable modifications added.

Unless stated otherwise, the remarks to preferred embodiments apply both to the use of the invention and the positive electrode active material of the invention as well as to the secondary battery of the invention.

### <Positive Electrode Active Material for Nonaqueous Electrolyte Secondary Battery and Use Thereof>

The positive electrode active material for a nonaqueous electrolyte secondary battery according to an embodiment of the present disclosure comprises a composite oxide that contains at least lithium, a transition metal, and oxygen, wherein, when a volume-based particle size frequency distribution of primary particles of the composite oxide is separated into a plurality of peaks, these peaks include specific peaks comprising: a main peak exhibiting a maximum value of peak area, and at least one peak having an area of 0.1-1, in terms of area ratio, with respect to the area of the main peak, and ratios of primary particle size (large particle size/small particle size) at peak tops of adjacent specific peaks are all 1.2-8.

The present inventors understood that a temperature at which the composite oxide releases oxygen correlates with the particle size distribution of the primary particles of the composite oxide. Specifically, the relationship is such that the greater the particle size of the primary particles of the composite oxide, the higher the oxygen release temperature. On making DTG measurements of the composite oxide, it was confirmed by TG-MS (thermogravimetric mass spectrometry) that virtually all of a weight reduction at a temperature up to around 310° C. was oxygen release, and the present inventors further found that there is a correspondence relationship between the temperature at each of the peak tops obtained when the DTG curve is separated into oxygen release peaks, and the particle size at each of the peak tops obtained when the particle size frequency distribution is separated into peaks.

Furthermore, it was also understood that the release amount of oxygen which is released from the composite oxide particles is dependent on the area of each of the peaks obtained when the particle size frequency distribution of the primary particles of the composite oxide is separated into peaks.

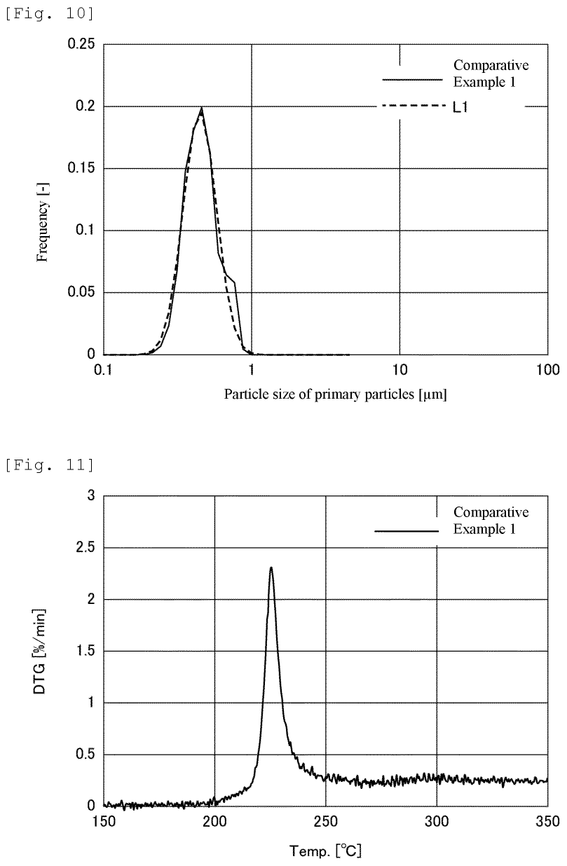

Assuming a case in which the particle sizes of the primary particles of the composite oxide are arranged so that there is only one sharp peak in the particle size frequency distribution and separation into peaks is not possible (see FIG. 10), or a case in which, even though separation into multiple peaks is possible, these peaks are close together, oxygen is released from the primary particles in a specific narrow temperature range in the DTG curve (see FIG. 11), and this oxygen reacts with the electrolytic solution, and therefore there is sudden heat generation causing thermal runaway.

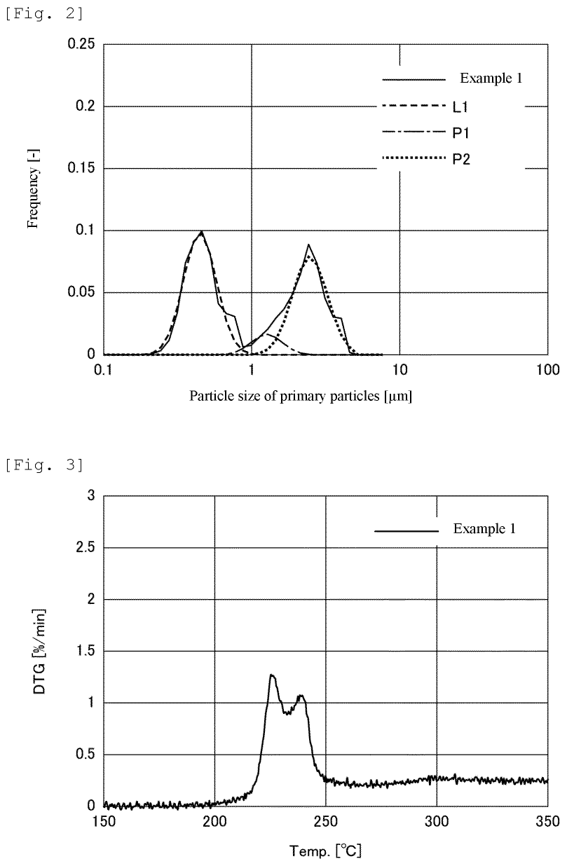

In contrast to this, in the positive electrode active material according to an embodiment of the present disclosure, this means that the volume-based particle size frequency distribution of the primary particles of the composite oxide can be separated into a plurality of peaks (specific peaks) having a fixed area or greater with respect to the main peak (see FIG. 2). In this kind of composite oxide, the oxygen release peaks in the DTG curve can then be separated into peaks (see FIG. 3). Furthermore, the fact that there are peaks having a fixed area greater or in the particle size frequency distribution of the primary particles means that a fixed amount or greater of oxygen is released. This further means that, by providing a plurality of such specific peaks, temperatures at which a fixed amount or greater of oxygen is released can be divided into multiple temperatures.

Furthermore, by setting a fixed ratio for the particle sizes of the primary particles corresponding to peak tops of adjacent specific peaks, a plurality of primary particles for which there is a fixed difference at the respective peak tops in the particle size frequency distribution are present together. As a result, a large difference is provided in the temperatures at which oxygen of a fixed amount or greater is released, and it is possible to inhibit sudden heat generation by the electrolytic solution by spreading the oxygen release amounts and temperatures.

It should be noted that “a plurality of primary particles . . . are present together” was indicated above, but this does not necessarily require an operation to mix a plurality of primary particles. There are also composite oxides having a plurality of specific peaks in the state of having been synthesized without further treatment, and such composite oxides may also be used without any mixing. Furthermore, composite oxides having a plurality of specific peaks may also be mixed, provided that the respective specific peaks have the relationship described above after the mixing.

The mechanism by which the composite oxide releases oxygen in a state of charge, which is a state in which lithium is released in a large amount from within the crystal structure and the crystal structure is generally in an unstable state, will be described below using the example of Li_{1-x-δ}NiO₂ (x+δ indicates the amount of Li withdrawn/released from LiNiO₂ due to charging). When this kind of composite oxide is used as the positive electrode active material and is heated in the state of charge, the crystalline state undergoes a phase transition from a layered rock-salt structure (R-3m) to a spinel structure (Fd-3m) or a rock salt structure (Fm3m) in a specific temperature range, as shown by formula (1) and formula (2) below. The temperatures of these phase transitions depend on a depth of charge, but the phase transition occurs in a temperature range of around 190-310° C. Furthermore, as is clear from formula (1) and formula (2), it is thought that the phase transition progresses while oxygen is generated.

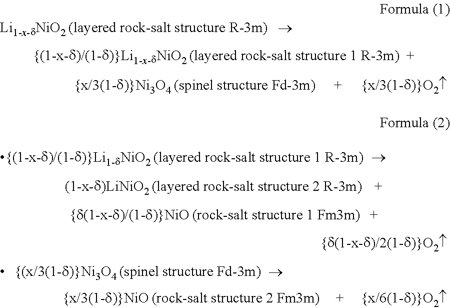

It should be noted that the symbol “-” is normally added over the 3 in R-3m, but this is indicated as above for convenience. The symbol “-” is likewise also added over the 3 in Fd-3m, but this is indicated as above for convenience.

The present inventors considered that the sudden formation of oxygen gas has a considerable effect on thermal stability of a charged nonaqueous electrolyte secondary battery.

When a nonaqueous electrolyte secondary battery in a state of charge is overheated and the temperature rises, the organic electrolytic solution in the nonaqueous electrolyte secondary battery is mainly oxidized (including being combusted) as a result of oxygen gas generated in the reaction of formula (1) or formula (2). This reaction is an exothermic reaction so the temperature of the nonaqueous electrolyte secondary battery rises. This rise in temperature further causes oxidation of the electrolytic solution and heat is generated, and therefore when the temperature rise lapses into an uncontrollable state, this leads to thermal runaway.

The rise in temperature is proportional to a difference between the amount of heat generated per unit time in the nonaqueous electrolyte secondary battery and the amount of heat dissipated per unit time from the nonaqueous electrolyte secondary battery. Accordingly, by ensuring that the amount of heat and the heat flow generated by formula (1) and formula (2) are not concentrated in a short time, it is possible to improve safety by inhibiting a rise in temperature and preventing uncontrollable thermal runaway.

In light of the above, the present inventors considered that limiting the rate of oxygen release from the positive electrode active material is the most important factor in inhibiting uncontrollable thermal runaway. It can then be said that controlling the particle size of the primary particles of the composite oxide such as in the present disclosure is effective for achieving this.

### [Chemical Structure]

There is no particular limitation as to the chemical structure of the composite oxide provided that the composite oxide contains at least lithium, a transition element, and oxygen.

There is no particular limitation as to the transition element, provided that it is an element belonging to groups 3-11 of the periodic table, but at least nickel is preferably used. Battery capacity can be increased by using nickel as the transition metal.

Specific examples of composite oxides which may be used include: lithium cobalt oxide (LiCoO₂), lithium nickel oxide (LiNiO₂), lithium manganese oxide (LiMnO₂), lithium manganese spinel (LiMn₂O₄), a composite oxide having a layered rock-salt structure with the general formula LiₐNi_{1-b-c}Mn_{b}M_{c}O₂ (in the formula, M is at least one element other than Li, Ni, Mn and O, 0.95≤a≤1.15, and 0≤b+c≤0.70) in which a portion of the Ni in lithium nickel oxide has been substituted with another element, a lithium vanadium compound (LiV₂O₅), olivine LiMPO₄ (where M is at least one element selected from Co, Ni, Mn, Fe, Mg, Nb, Ti, Al and Zr; or is VO), lithium titanium oxide (Li₄Ti₅O₁₂), and LiNiₐCo_{b}Al_{c}O₂ (0.9<a+b+c<1.1), etc.

Among the composite e oxides mentioned above, use is preferably made of a lithium-nickel composite oxide, more preferably of a lithium-nickel composite oxide which has a layered rock-salt structure and is represented by the general formula LiₐNi_{1-b-c}Mn_{b}M_{c}O₂ (in the formula, M is at least one element other than Li, Ni, Mn and 0, 0.95≤a≤1.15, and 0≤b+c≤0.70). Specific examples of the element M other than Li, Ni and O which may be used include: Co, Al, Mn, Ti, Mg, Zn, Nb, W, Mo, Sb, V, Cr, Ca, Fe, Ga, Sr, Y, Ru, In, Sn, Ta, Bi, Zr and B, etc. More specific examples are Co, Al, Mn, Mg, Zn, Nb, W, Mo, Sb, V, Cr, Ca, Fe, Ga, Sr, Y, Ru, In, Sn, Ta, Bi, and B. The use of such a lithium-nickel composite oxide as the positive electrode active material for a nonaqueous electrolyte secondary battery makes it possible to increase the battery capacity, but also has the feature of leading to the release of oxygen from the crystal structure, which is likely to cause thermal runaway. Thermal runaway caused by oxygen release is inhibited by using the positive electrode active material for a nonaqueous electrolyte secondary battery according to an embodiment of the present disclosure, in order to take advantage of the high battery capacity of the abovementioned lithium-nickel composite oxide.

While there is no particular limitation to M, in a specific embodiment M is Co or Al or stands for both Co and Al (i.e. both of Co and Al are present in the composite). More specifically, M is Co or is both Co and Al. Even more specifically, M is both Co and Al.

Furthermore, there is no particular limitation as to b+c, provided that it is within the range of 0≤b+c≤0.70, and it may be, for example 0.65 or less, 0.60 or less, 0.55 or less, 0.50 or less, 0.45 or less, 0.40 or less, 0.35 or less, 0.30 or less, 0.25 or less, or 0.20 or less. If b+c is small, this means that there is a high nickel content. When there is a high nickel content, this increases the oxygen release amount and therefore tends to make thermal runaway more likely to occur. Meanwhile, by virtue of the positive electrode active material for a nonaqueous electrolyte secondary battery according to an embodiment of the present disclosure, thermal runaway can be inhibited even if a compound having a high nickel content is used.

In a particular embodiment 0<b+c≤0.70, i.e. at least one of Mn and M is present in the composite. Preferably, 0<b+c≤0.60, more preferably 0.05≤b+c≤0.50, in particular 0.05≤b+c≤0.40, more particularly 0.05≤b+c≤0.30, specifically 0.10≤b+c≤0.25 or 0.15≤b+c≤0.20.

Preferably, 0.98≤a≤1.10, more preferably 1.00≤a≤1.10. In a particular embodiment, the composite oxide is one of the formula LiₐNi_{1-b-c1-c2}Mn_{b}Co_{c1}Al_{c2}O₂, where 0.95≤a≤1.15, 0.75≤[1−b−c1−c2]≤0.90; 0.01≤b≤0.10; 0.05≤c1≤0.20 and 0≤c2≤0.05.

In another particular embodiment, the composite oxide is one of the formula LiₐNi_{1-b-c1-c2}Mn_{b}Co_{c1}Al_{c2}O₂, where 0.98≤a≤1.10, 0.80≤[1−b−c1−c2]≤0.85; 0.02≤b≤0.08; 0.10≤c1≤0.15 and 0≤c≤0.03.

In a specific embodiment, the composite oxide is one of the formula LiₐNi_{1-b-c1-c2}Mn_{b}Co_{c1}Al_{c2}O₂, where 1.04≤a≤1.05, 0.82≤[1−b−c1−c2]≤0.84; 0.04≤b≤0.06; 0.11≤c1≤0.13 and 0≤c2≤0.02.

In another specific embodiment, the composite oxide is one of the formula LiₐNi_{1-b-c1-c2}Mn_{b}Co_{c1}Al_{c2}O₂, where 1.04≤a≤1.05, 0.82≤[1−b−c1−c2]≤0.84; 0.04≤b≤0.06; 0.11≤c1≤0.13 and 0≤c2<0.02.

In a very specific embodiment, the composite oxide is one of the formula LiₐNi_{1-b-c1-c2}Mn_{b}Co_{c1}Al_{c2}O₂, where 1.04≤a≤1.05, 0.82≤[1−b−c1−c2]≤0.84; 0.04<b≤0.06; 0.11<c1≤0.13 and 0<c2<0.02.

Controlled oxygen release and thus reduced inhibited thermal runaway is however also obtained with composites different from those of the above particular and specific embodiments if the claimed volume-based primary particle size frequency distribution characteristic is fulfilled.

### [Primary Particles]

The primary particles of the composite oxide refer to minimum units of a particulate material in which grain boundaries are not present, when a powder of the composite oxide is observed under a field emission scanning electron microscope.

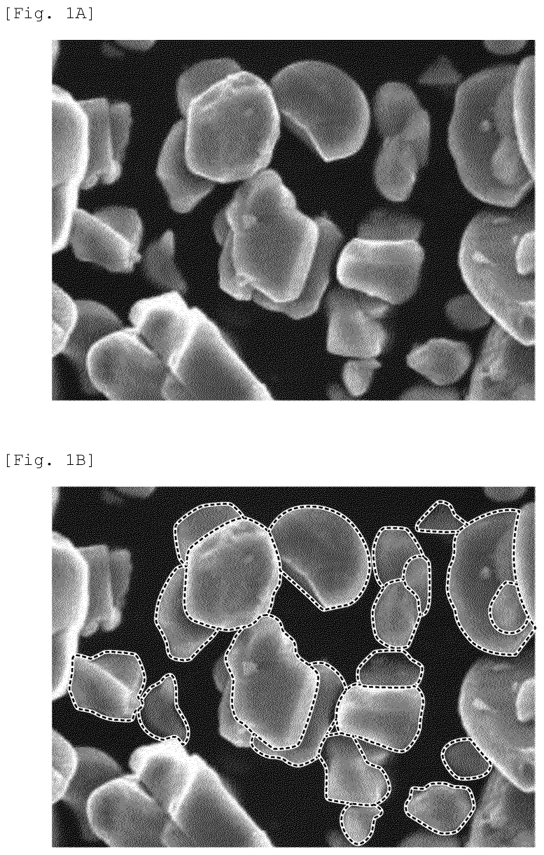

FIG. 1A is an example of a scanning electron microscope photograph of the composite oxide. FIG. 1B is a diagram in which the primary particles are enclosed by broken lines in the scanning electron microscope photograph of the composite oxide of FIG. 1A. As shown in FIGS. 1A and 1B, the particulate material in which grain boundaries are not present are taken as the primary particles.

The primary particles may agglomerate to form secondary particles, or may be present simply as primary particles, or else secondary particles and primary particles may be mixed. If the primary particles have the same particle size distribution, then the temperature at which oxygen is released from the composite metal oxide does not change by a large amount, whatever the state in which the primary particles are present.

Furthermore, when the primary particles agglomerate to form secondary particles, primary particles exhibiting a plurality of specific peaks may be mixed within one secondary particle, or multiple types of secondary particles comprising an agglomeration of only primary particles exhibiting the same specific peak may be present together.

### (Specific Peaks)

When the volume-based particle size frequency distribution of the primary particles is separated into a plurality of peaks, the specific peaks comprise a main peak exhibiting a maximum value of peak area, and at least one peak having an area of 0.1-1, in terms of area ratio, with respect to the area of the main peak.

The particle size frequency distribution is obtained by the following method. An electron microscope photograph observation is made using a field emission scanning electron microscope (e.g. JSM-7100F: produced by JEOL Ltd.) with an acceleration voltage of 10 kV and a magnification of 3000-20,000 times. Specifically, one field of view in which at least 100 primary particles for which the particle outline can be confirmed are visible is randomly selected, and an electron microscope photograph is obtained while varying the magnification within the abovementioned range, as required, for all of the particles for which the outline can be confirmed from among the particles included in that field of view. For example, if there is a large difference in particle size and the outlines of the particles cannot be confirmed in one field of view at one magnification, etc., the electron microscope photograph may be divided into multiple photographs, as required. A sphere-equivalent diameter is calculated using image processing software (e.g., ImageJ, etc.), and this serves as the particle size of the primary particles. In this case, the scale displayed in the electron microscope photograph is used as a reference scale.

A kernel density distribution (number-based) employing a standard normal distribution as a kernel function is calculated from the data of the particle sizes of the primary particles obtained. After this, the primary particles are sphere-approximated and the volume-based particle size frequency distribution is obtained from the number-based distribution. It should be noted that in the volume-based particle size frequency distribution, the logarithm of the particle size is used as the horizontal axis. Furthermore, the reliability of the bandwidth parameter h relating to the distribution is determined with reference to Silverman's bandwidth (see equation (1) below) (Silverman, B. W.: Density Estimation for Statistics and Data Analysis. Chapman & Hall, London-New York 1986, 175).

$$[ Equation 1 ]$$

$$h = 0.9 σ {n}^{- 1 / 5} \\ σ = min ( \hat{σ} , \frac{IQR}{1.349} ) , \hat{σ} , : \qquad ( 1 )$$

standard deviation, IQR (Interquartile range): value obtained by subtracting 25^{th} percentile (first quartile, Q1) from 75^{th} percentile (third quartile, Q3), n: measured number of particles

The volume-based particle size frequency distribution obtained in this way is then fitted using a logarithmic normal distribution function and separated into peaks, to thereby calculate the particle size at the peak top of each of the peaks (central particle size of primary particles) and peak areas of the respective peaks.

It should be noted that if peaks that do not satisfy specific peaks (peaks of less than 0.1 in terms of area ratio with respect to the area of the main peak) are apparent when the peaks are separated, those peaks are deemed not to be peaks and are ignored, then the peaks are again separated.

There is no particular limitation as to the peaks corresponding to specific peaks provided that they have an area of 0.1-1 in terms of area ratio with respect to the area of the main peak, and they may have an area ratio of 0.11 or greater, 0.12 or greater, 0.13 or greater, 0.14 or greater, 0.15 or greater, 0.16 or greater, 0.17 or greater, 0.18 or greater, 0.19 or greater, 0.2 or greater, 0.22 or greater, 0.25 or greater, 0.27 or greater, 0.3 or greater, 0.32 or greater, 0.35 or greater, 0.37 or greater, 0.4 or greater, 0.45 or greater, or 0.5 or greater. The effect of inhibiting thermal runaway can be further enhanced by setting the area ratio at or above the desired value.

When there are a plurality of peaks exhibiting a maximum value of peak area, the peak having the smallest primary particle size at the peak top thereof is taken to be the main peak, and the other peaks exhibiting a maximum value of peak area are included in the specific peaks.

It is important for the peaks to be scattered for the primary particle size at the peak tops of the specific peaks, and although there is no particular limitation, the primary particle sizes are all preferably 80 nm or greater, 100 nm or greater, 120 nm or greater, 150 nm or greater, 170 nm or greater, 200 nm or greater, 250 nm or greater, 300 nm or greater, 350 nm or greater, 400 nm or greater, or greater. 450 nm or The oxygen release temperature can be increased by setting the primary particle size at the peak tops of the specific peaks at or above the desired value. Meanwhile, the primary particle size at the peak tops of the specific peaks is preferably 15 μm or less, 14.5 μm or less, 14 μm or less, 13.5 μm or less, 13 μm or less, 12.5 μm or less, 12 μm or less, 11.5 μm or less, 11 μm or less, 10.5 μm or less, 10 μm or less, 9.5 μm or less, 9 μm or less, 8.5 μm or less, 8 μm or less, 7.5 μm or less, 7 μm or less, 6.5 μm or less, 6 μm or less, 5.5 μm or less, 5 μm or less, or 4.5 μm or less. The energy density can be increased and it is possible to inhibit particle damage accompanying cycling and a reduction in rate characteristics by setting the particle size at the peak tops of the specific peaks at or below the desired value.

There is no particular limitation as to the ratios of the primary particle size at the peak tops of adjacent specific peaks (large particle size/small particle size) provided that the ratios are all 1.2-8, and they are all preferably 1.22 or greater, 1.25 or greater, 1.27 or greater, 1.3 or greater, 1.32 or greater, 1.35 or greater, 1.37 or greater, 1.4 or greater, 1.45 or greater, 1.5 or greater, 1.55 or greater, 1.6 or greater, 1.65 or greater, 1.7 or greater, 1.75 or greater, 1.8 or greater, 1.85 or greater, 1.9 or greater, 1.95 or greater, 2 or greater, 2.1 or greater, 2.2 or greater, 2.3 or greater, 2.4 or greater, 2.5 or greater, 2.6 or greater, 2.7 or greater, 2.8 or greater, 2.9 or greater, or 3 or greater. A plurality of temperatures at which oxygen is released from the composite oxide can be properly separated and the effect of inhibiting thermal runaway can be further enhanced by setting the ratios of the primary particle size at the peak tops of adjacent specific peaks at or above the desired value. Meanwhile, the ratios of the primary particle size at the peak tops of adjacent specific peaks are preferably 7.7 or less, 7.5 or less, 7.2 or less, 7 or less, 6.7 or less, 6.5 or less, 6.2 or less, 6 or less, 5.7 or less, 5.5 or less, 5.2 or less, 5 or less, 4.7 or less, 4.5 or less, 4.2 or less, or 4 or less. It is possible to limit variations in properties of primary particles exhibiting the respective specific peaks by setting the primary particle size ratios at the peak tops of adjacent specific peaks at or below the desired value.

Specifically, when there are 4 peak tops of specific peaks and the primary particle sizes of the respective peaks are A, B, C and D with the primary particle size increasing in that order, the ratios of the primary particle size at the peak tops of the adjacent specific peaks are A/B, B/C and C/D, and all of the ratios are preferably within the abovementioned ranges.

### [Maximum Oxygen Release Rate]

There is no particular limitation as to the maximum oxygen release rate of the composite oxide, but it is preferably 1.92% or less, 1.9% or less, 1.85% or less, 1.8% or less, 1.75% or less, 1.7% or less, 1.65% or less, 1.6% or less, 1.55% or less, 1.5% or less, 1.45% or less, 1.4% or less, 1.35% or less, 1.3% or less, 1.25% or less, or 1.2% or less, for example.

It should be noted that the maximum oxygen release rate is obtained by the following method using a thermogravimetry differential thermal analysis (TG-DTA) apparatus (e.g. DTG-60H, produced by Shimadzu Corp.).

### (Sample Preparation)

A 2032 type coin cell employing lithium as a counter electrode is prepared in accordance with the method described below, and after constant current charging to 4.30 V at 0.3 C under an environment of 25° C., constant voltage charging is performed until a current value of 0.05 C is reached. After this, there is a pause of 20 minutes following the completion of charging, constant current discharging at 0.3 C is performed to 2.50 V, after which constant current discharging is performed at 0.1 C, then there is a pause of 20 minutes. This charging and discharging are repeated twice. After constant current charging to 4.30 V at 0.3 C, constant voltage charging is then performed until a current value of 0.05 C is reached, and there is a pause of 20 minutes after the completion of charging.

The coin cell in a state of charge is disassembled inside a glove box (dew point: −70° C. or less) so that short-circuiting does not occur, and the positive electrode is collected. The collected positive electrode is washed for 10 minutes in DMC and dried under a vacuum inside a side box. After this, a positive electrode compound material is scraped from an Al foil using a spatula inside the same glove box. A TG measurement vessel made of Al is filled with 15 mg of a powder of the positive electrode compound material obtained, then covered with a lid and hermetically sealed using a crimping machine.

The Al measurement vessel obtained in this way is removed from the glove box and left to stand on a measurement-side balance of the TG-DTA apparatus.

### (Tg-Dta Measurement)

Reference: Pt vessel filled with 15-20 mg Al₂O₃
Maximum temperature: 600° C.
Temperature Increase Rate:
   (1) 25° C. (room temperature) to 50° C.: 1° C./min
   (2) 50° C. to 600° C.: 5° C./min
Measurement environment: N₂ gas atmosphere (200 mL/min)

Immediately before the measurement, small holes are formed in the lid of the hermetically sealed Al measurement vessel inside the TG-DTA apparatus which is under the N₂ gas atmosphere, after which the temperature increase is started. By using this method, the positive electrode compound material powder for measurement can be measured without exposure to the atmosphere.

Based on the results obtained, a DTG curve is produced in which the horizontal axis is temperature and the vertical axis is a time-differentiated value of a weight change (TG) (this value is dTG, meaning a weight reduction rate, corresponding to the oxygen release rate of the composite oxide), and the maximum weight reduction rate among peaks apparent in the region of 150° C.-350° C. is taken as the maximum oxygen release rate (%/min).

### <Method for Producing Positive Electrode Active Material for a Nonaqueous Electrolyte Secondary Battery>

The positive electrode active material for a nonaqueous electrolyte secondary battery according to an embodiment of the present disclosure may be produced by performing the following steps in the order stated, for example. It should be noted that the following description gives an example of a method for producing a composite oxide comprising 30 mol % or more of Ni in elements other than Li, and the method for producing the composite oxide is otherwise in accordance with a normal process.

Step 1: A precursor composite compound containing at least a transition metal is synthesized, and the precursor composite compound is mixed with a lithium compound to prepare a mixture.

Step 2: The mixture prepared in step 1 is fired.

Step 3: The composite oxide obtained by firing in step 2 is subjected to a water washing treatment, as required.

Step 4: The composite oxide obtained in step 2 or 3 is subjected to a surface treatment, as required.

Step 5: Multiple types of composite oxides with varying primary particle sizes and particle size frequency distributions are mixed by varying the conditions of steps 1-3, as required.

### [Step 1]

A precursor composite compound serving as an agglomerate comprising a mass of primary particles containing at least a transition metal is first of all synthesized. There is no particular limitation as to the method for synthesizing the precursor composite compound, and, for example, an aqueous solution comprising a transition metal aqueous solution and various types of aqueous solutions of compounds comprising another element, according to the intended composition of the composite oxide, are dripped into a reaction tank with stirring, using an alkaline aqueous solution such as a sodium hydroxide aqueous solution or an ammonia solution, for example, as a mother liquor, the pH is monitored and controlled to a suitable range while sodium hydroxide, etc. is also dripped, and the precursor composite compound is obtained by coprecipitation by means of a wet reaction, and it is possible to use a method of obtaining the precursor composite compound as a hydroxide, an oxide obtained by calcining the hydroxide, or a carbonate, etc., for example.

It should be noted that, once the alkaline aqueous solution serving as the mother liquor has been prepared for the reaction relating to the synthesis, an inert gas, or nitrogen gas which is industrially preferred, is preferably used to set a nitrogen atmosphere inside the reaction tank so that the oxygen concentration inside the reaction tank system and in the solutions is as low as possible. If the oxygen concentration is excessively high, there is a risk of excessive oxidation of the coprecipitated hydroxide due to residual oxygen at or above a predetermined amount, and there is a risk of obstructing formation of the agglomerate due to crystallization.

There is no particular limitation as to the transition metal aqueous solution, but an acidic aqueous solution is preferably used, for example, and a sulfuric acid aqueous solution such as a nickel sulfate aqueous solution is more preferably used. Furthermore, one or more types of transition metal aqueous solution may be used.

There is no particular limitation as to a titanium compound, but it is possible to use, for example, one or more selected from: titanyl sulfate, titanium oxide, titanium hydroxide, titanium nitrate, titanium carbonate, titanium chloride, titanium iodide, and metallic titanium, etc.

There is no particular limitation as to an iron compound, but it is possible to use, for example, one or more selected from: iron sulfate, iron oxide, iron hydroxide, iron nitrate, iron carbonate, iron chloride, iron iodide, and metallic iron, etc.

There is no particular limitation as to a manganese compound, but it is possible to use, for example, one or more selected from: manganese sulfate, manganese oxide, manganese hydroxide, manganese nitrate, manganese carbonate, manganese chloride, manganese iodide, and metallic manganese, etc.

There is no particular limitation as to a cobalt compound, but it is possible to use, for example, one or more selected from: cobalt sulfate, cobalt oxide, cobalt hydroxide, cobalt nitrate, cobalt carbonate, cobalt chloride, cobalt iodide, and metallic cobalt, etc.

There is no particular limitation as to a nickel compound, but it is possible to use, for example, one or more selected from: nickel sulfate, nickel oxide, nickel hydroxide, nickel nitrate, nickel carbonate, nickel chloride, nickel iodide, and metallic nickel, etc.

There is no particular limitation as to a niobium compound, but it is possible to use, for example, one or more selected from: niobium oxide, niobium chloride, lithium niobate, and niobium iodide, etc.

There is no particular limitation as to a tungsten compound, but it is possible to use, for example, one or more selected from: tungsten oxide, sodium tungstate, ammonium paratungstate, tungsten hexacarbonyl, and tungsten sulfide, etc.

There is no particular limitation as to a magnesium compound, but it is possible to use, for example, one or more selected from: magnesium sulfate, magnesium oxide, magnesium hydroxide, magnesium nitrate, magnesium carbonate, magnesium chloride, magnesium iodide, and metallic magnesium, etc.

There is no particular limitation as to an aluminum compound, but it is possible to use, for example, one or more selected from: aluminum sulfate, aluminum oxide, aluminum hydroxide, aluminum nitrate, aluminum carbonate, aluminum chloride, aluminum iodide, sodium aluminate, and metallic aluminum, etc.

There is no particular limitation as to a zinc compound, but it is possible to use, for example, one or more selected from: zinc sulfate, zinc oxide, zinc hydroxide, zinc nitrate, zinc carbonate, zinc chloride, zinc iodide, and metallic zinc, etc.

For other elements also, it is possible to use one or more selected from sulfates, oxides, hydroxides, nitrates, carbonates, chlorides, iodides, and metals, etc.

The proportions in which the respective compounds are blended should be appropriately adjusted while taking account of the intended composition of the composite oxide so that the amounts of the respective elements reach the desired proportions.

There is no particular limitation as to an appropriate pH range when the precursor composite compound is synthesized, and it may be determined so as to achieve a desired secondary particle size and coarseness/fineness, and the pH should generally be in a range of around 10-13.

The precursor composite compound obtained by means of a wet reaction is preferably subjected to a washing treatment and then a drying treatment after dewatering.

By subjecting the precursor composite compound to the washing treatment, it is possible to rinse off impurities taken into agglomerated particles or adhering to a surface layer during the reaction, such as sulfate radicals and carbonate radicals, and a sodium fraction. Washing treatments which may be used include a process of Nutsche washing employing a Büchner funnel, provided that there is only a small amount of impurity, and a process of feeding a suspension after the reaction to a press filter, washing with water and dewatering. It should be noted that the washing treatment may employ pure water, a sodium hydroxide aqueous solution, or a sodium carbonate aqueous solution, etc., but pure water is preferably used from an industrial point of view. However, when there is a large quantity of residual sulfate radicals, it is also possible to use a sodium hydroxide aqueous solution which is pH-controlled according to the residual amount.

The precursor composite compound synthesized in this way and a lithium compound are then mixed in a predetermined ratio to prepare a mixture. The mixing may be solvent-based mixing in which the precursor composite compound and the lithium compound are each in the form of a solution, such as an aqueous solution, and the solutions are mixed in a predetermined ratio, or it may be non-solvent-based mixing in which a powder of the precursor composite compound and a powder of the lithium compound are weighed out in predetermined proportions and mixed by a dry method.

There is no particular limitation as to the lithium compound, and various types of lithium salts may be used. Specific examples of lithium compounds which may be used include one or more selected from: anhydrous lithium hydroxide, lithium hydroxide hydrate, lithium nitrate, lithium carbonate, lithium acetate, lithium bromide, lithium chloride, lithium citrate, lithium fluoride, lithium iodide, lithium lactate, lithium oxalate, lithium phosphate, lithium pyruvate, lithium sulfate, and lithium oxide, etc. Among these, one or more selected from anhydrous lithium hydroxide and lithium hydroxide hydrate is preferably used.

There is no particular limitation as to the proportions in which the lithium compound and the precursor composite compound are blended, but the proportions should be appropriately adjusted while taking account of the intended composition of the composite oxide so that the amount of lithium and the total amounts of the respective elements reach the desired proportions.

### [Step 2]

A lithiation reaction and crystal growth are achieved in the firing when the composite oxide containing at least a transition metal is produced, as indicated above, and in this process, a fixed oxygen partial pressure is required for the lithiation reaction. The composite oxide containing lithium is obtained by means of the lithiation reaction. After this, crystal growth is promoted by raising the temperature to a predetermined temperature.

The maximum temperature of the mixture in the firing is preferably 650° C.-1100° C., 670-1000° C., or 700° C.-980° C. Furthermore, the firing time at the maximum temperature is preferably 1-24 hours, 1-20 hours, 1-15 hours, 1-10 hours, 2-9 hours, or 3-8 hours. It is possible to obtain the desired composite compound by setting the maximum temperature and time so that the firing temperature is equal to or greater than the melting point of the lithium compound in the mixture, and so that the composite oxide containing lithium achieves the desired crystal growth and particle growth.

The firing is generally carried out by weighing out the lithium compound, precursor composite compound, and a compound M, as required, and mixing these compounds in a mixer to obtain a mixed powder which is then packed in a vessel such as a crucible or a saggar, but in the lithiation reaction in particular, it becomes difficult to expel the generated gas to the outside and to diffuse oxygen at the required concentration, especially closer to the lower part of the vessel packed with the mixed powder. As a result, it is difficult to achieve a uniform reaction and to control the primary particle size.

When the composite oxide according to an embodiment of the present disclosure is produced, it is therefore preferable to use a method in which a preliminary firing is first of all carried out under the following predetermined conditions in step 2, after which a main firing is performed under predetermined conditions. The preliminary firing is not an essential step, however.

In the preliminary firing of step 2, a firing method that especially promotes the lithiation reaction is preferably adopted. In a method which may be specifically cited, the mixture is placed in a state in which heat more readily acts thereon, the gas generated from the lithiation reaction is easily expelled, and a gas with a high oxygen partial pressure is able to diffuse within the mixture (within the particles). For example, the desired characteristics may be achieved by subjecting a smaller amount of the mixture to the preliminary firing.

When the mixture is subjected to preliminary firing in step 2, the mixture is packed in a saggar or crucible, and the firing may also be performed in a static furnace or a roller hearth kiln or a pusher furnace, but a rotary kiln for firing the mixture while it is fluidized may be used.

There is no particular limitation as to the maximum temperature of the mixture which undergoes the preliminary firing, and the maximum temperature is preferably adjusted in accordance with the type of lithium compound used for preparing the mixture. By this means, a reliable reaction is produced between the precursor composite compound and the lithium compound in the mixture, the lithiation reaction proceeds uniformly and reliably, it is possible to ensure that different phases are not formed, and the intended composite oxide can be obtained.

There is no particular limitation as to the atmosphere in the preliminary firing, and it may be an oxidizing atmosphere such that the lithiation reaction proceeds reliably and uniformly. For example, a decarbonated oxidizing gas atmosphere having a carbon dioxide concentration of 30 ppm or less, or an oxygen atmosphere having an oxygen concentration of 80 vol %-90 vol % is preferably used.

There is no particular limitation as to the time of the preliminary firing, and it should be a time such that the lithiation reaction proceeds reliably and uniformly. A time of 1 hour-10 hours or 2 hours-8 hours is preferred, for example.

In order to promote crystal growth and particle growth at an even higher temperature, the mixture which has undergone the preliminary firing is subjected to a main firing. In this case, it is necessary to cause crystal growth to proceed reliably and uniformly, and to obtain a composite oxide having the desired crystal structure.

There is no particular limitation as to the atmosphere for the main firing, and it may be an atmosphere in which reliable and uniform crystal growth is achieved, with an oxygen partial pressure such that the transition metal contained in the mixture being fired is not reduced, preferably an atmosphere having a low moisture content and carbon dioxide concentration. For example, a decarbonated oxidizing gas atmosphere having a carbon dioxide concentration of 30 ppm or less, or an oxygen atmosphere preferably having an oxygen concentration of 80 vol %-90 vol % is preferably used.

There is no particular limitation as to the temperature in the main firing provided that it is a higher temperature than the temperature in the preliminary firing, and it may be adjusted according to the composition, etc. of the composite oxide to be obtained. For example, the maximum temperature is preferably adjusted to 700° C.-1100° C., 710° C.-1000° C., or 720° C.-980° C. By setting the maximum temperature within the desired range, it is possible to obtain a composite oxide having the desired crystal structure with fewer unreacted components, and, furthermore, it is also possible to prevent a drop characteristics the in battery of nonaqueous electrolyte secondary battery employing the resulting composite oxide in a positive electrode thereof. Furthermore, when a composite oxide having an Ni content of 20 mol %-80 mol % in the elements other than Li is obtained, for example, the firing is preferably performed with the maximum temperature of the mixture not exceeding 1100° C.

There is no particular limitation as to the time of the main firing, and it may be a time sufficient for a composite oxide having the desired crystal structure to be formed. A time of 1 hour-15 hours, 2 hours-12 hours, or 2 hours-10 hours is preferred, for example.

### [Step 3]

Unreacted lithium compound and lithium compound which emerges in a particle surface layer from the crystal structure in the process of the firing step are sometimes present as impurities in the composite oxide obtained in step 2. For this reason, a water washing and heat treatment may be performed, for example, in order to remove and reduce these impurities. It should be noted that step 3 is not an essential component.

### [Step 4]

A predetermined element compound may be admixed with the composite oxide obtained in step 2 or 3 and a heat treatment may be implemented in order to surface treat the surfaces of the primary particles and/or secondary particles of the composite oxide using a compound of lithium and the added element, and this makes it possible to achieve effects such as reducing the lithium compound remaining on the particle surface layer, improving lithium ion conductivity, and reducing reaction resistance. It should be noted that step 4 is not an essential component.

The element compound added for this surface treatment may be selected from an aluminum compound, a boron compound, a tungsten compound, a manganese compound, a cobalt compound, a phosphorus compound, a niobium compound, a strontium compound, an antimony compound, a zirconium compound, and a titanium compound, etc., and one or more of these compounds may be used, for example.

### [Step 5]

When the composite oxide obtained in any of steps 2-4 does not alone have a plurality of the abovementioned specific peaks, or does not alone have the abovementioned specific primary particle size ratio, or when there is a wish to further increase the effect of inhibiting thermal runaway even though the specific requirements are satisfied in regard to the specific peaks and primary particle size ratio, etc., multiple types of composite oxides in which the primary particle sizes and particle size frequency distributions are varied by changing the conditions in the production of the composite oxide (the conditions of steps 1-4) are mixed. It should be noted that step 5 is not an essential component when the composite oxide obtained in any of steps 2-4 alone satisfies the specific requirements in regard to specific peaks and primary particle size ratio.

Moreover, the order of steps 3-5 may be varied.

### <Nonaqueous Electrolyte Secondary Battery>

A nonaqueous electrolyte secondary battery according to the present disclosure comprises a positive electrode containing the abovementioned composite oxide as a positive electrode active material, and the nonaqueous electrolyte secondary battery comprises the positive electrode, a negative electrode, and an electrolytic solution comprising an electrolyte.

When the positive electrode is produced, a conductive agent and a binder are admixed with the composite oxide according to an embodiment of the present disclosure by means of a normal process. Acetylene black, carbon black, and graphite, etc. are preferably used as a conductive agent, for example. Polytetrafluoroethylene and polyvinylidene fluoride, etc. are preferably used as a binder, for example.

There is no particular limitation as to the negative electrode, but it is possible to use not only negative electrode active materials such as lithium metal, graphite, and low-crystallinity carbon materials, for example, but also at least one non-metal or metal element selected from Si, Al, Sn, Pb, Zn, Bi and Cd, or alloys comprising same, or chalcogen compounds comprising same, etc.

There is no particular limitation as to the solvent of the electrolytic solution, but examples of solvents that may be used include organic solvents comprising at least one selected from carbonates such as ethylene carbonate, dimethyl carbonate and diethyl propylene carbonate, carbonate, and ethers such as dimethoxyethane.

lithium hexafluorophosphate (LiPF₆) in Other than particular, at least one selected from lithium salts such as lithium perchlorate or lithium tetrafluoroborate, for example, may be dissolved in the solvent for use as the electrolyte.

### EXAMPLES

The present disclosure will be described in further detail below by means of examples, but the present disclosure is not limited by these examples.

### <Preparation of Composite Oxides>

Composite oxides 1-3 were prepared by means of the methods described below.

### (Preparation of Composite Oxide 1)

A nickel-cobalt-manganese composite hydroxide represented by the compositional formula Ni_{0.83}Co_{0.12}Mn_{0.05}(OH)₂ was obtained by means of coprecipitation. The volume-based D₅₀ of substantially spherical agglomerated particles obtained in this way was 11.2 μm.

The resulting nickel-cobalt-manganese composite hydroxide, lithium hydroxide, and aluminum hydroxide were weighed out and mixed so that Li/(Ni+Co+Mn)=1.04 and Al/(Ni+Co+Mn)=0.5 mol %. After this, the mixture was heat-treated for 6 hours at 570° C. under an oxygen atmosphere, then further fired for 6 hours at 775° C. under an oxygen atmosphere (oxygen concentration: 97 vol %). The resulting fired material was ground to obtain a lithium-nickel composite oxide.

A slurry prepared by mixing a powder of the resulting lithium-nickel composite oxide with pure water temperature-adjusted to 25° C. at a ratio of 1500 g/L was stirred for 10 minutes then dewatered to obtain a cake-like compound. The cake-like compound was dried in a vacuum dryer for 2 hours at 75° C. and 10 hours at 120° C.

1000 ppm boron was admixed as a boron compound with the resulting lithium-nickel composite oxide, and the mixture was heat treated for 2 hours at 325° C. under an oxygen atmosphere (oxygen concentration: 97 vol %) to thereby obtain composite oxide 1 having a particle size (central particle size) at a peak top of a particle size frequency distribution of primary particles of 0.5 μm (L1).

### (Preparation of Composite Oxide 2)

A nickel-cobalt-manganese composite hydroxide represented by the compositional formula Ni_{0.83}Co_{0.12}Mn_{0.05}(OH)₂ was obtained by means of coprecipitation. The volume-based D₅₀ of substantially spherical agglomerated particles obtained in this way was 4.1 μm.

The resulting nickel-cobalt-manganese composite hydroxide and lithium hydroxide powder were weighed out and mixed so that Li/(Ni+Co+Mn)=1.05. After this, the mixture was fired for 12 hours at 860° C. under an oxygen atmosphere (oxygen concentration: 97 vol %). The resulting fired material was ground and a supply pressure and grinding pressure were adjusted using a jet mill so that the primary particles were not ground. After this, 0.6 mol % aluminum oxide powder Al₂O₃ was added and a heat treatment was performed for 7 hours at 600° C. under air atmosphere to thereby obtain a lithium-metal composite oxide.

A slurry prepared by mixing a powder of the resulting lithium-nickel composite oxide with pure water temperature-adjusted to 25° C. at a ratio of 1500 g/L was stirred for 10 minutes then dewatered to obtain a cake-like compound. After this, the cake-like compound was dried in a vacuum dryer for 2 hours at 75° C. and 10 hours at 120° C.

500 ppm boron was admixed as a boron compound with the resulting lithium-nickel composite oxide, and the mixture was heat treated for 7 hours at 300° C. under the atmosphere to thereby obtain composite oxide 2 having two peaks when the particle size frequency distribution of primary particles was separated into peaks, the particle size (central particle size) at each of the peak tops being 1.4 μm (P1) and 2.7 μm (P2).

### (Preparation of Composite Oxide 3)

A nickel-cobalt-manganese composite hydroxide represented by the compositional formula Ni_{0.83}Co_{0.12}Mn_{0.05}(OH)₂ was obtained means of coprecipitation. The volume-based D₅₀ of substantially spherical agglomerated particles obtained in this way was 4 μm.

The resulting nickel-cobalt-manganese composite hydroxide and lithium hydroxide powder were weighed out and mixed so that Li/(Ni+Co+Mn)=1.05. After this, the mixture was fired for 12 hours at 850° C. under an oxygen atmosphere (oxygen concentration: 97 vol %). After this, 0.6 mol % Al₂O₃ was added as aluminum oxide and a heat treatment was performed for 7 hours at 600° C. under the atmosphere to thereby obtain a lithium-metal composite oxide.

A slurry prepared by mixing a powder of the resulting lithium-nickel composite oxide with pure water temperature-adjusted to 25° C. at a ratio of 1500 g/L was stirred for 10 minutes then dewatered to obtain a cake-like compound. After this, the cake-like compound was dried in a vacuum dryer for 2 hours at 75° C. and 10 hours at 120° C.

500 ppm boron was admixed as a boron compound with the resulting lithium-nickel composite oxide, and the mixture was heat treated for 7 hours at 300° C. under air atmosphere to thereby obtain composite oxide 3 having three peaks when the particle size frequency distribution of primary particles was separated into peaks, the particle size (central particle size) at each of the peak tops being 1.5 μm (M1), 2.2 μm (M2), and 3.0 μm (M3).

### Example 1

Composite oxide 1 and composite oxide 2 were mixed so that the peak area ratio was 50:50 and used as a positive electrode active material sample. FIG. 2 is a volume-based particle size frequency distribution chart of the primary particles of the positive electrode active material sample of example 1. Furthermore, FIG. 3 is a DTG curve of the positive electrode active material sample of example 1.

### Example 2

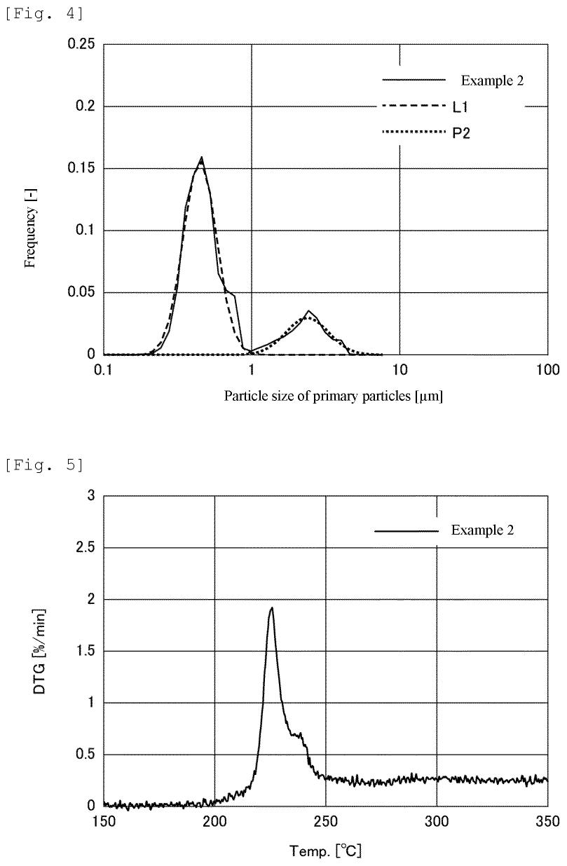

Composite oxide 1 and composite oxide 2 were mixed so that the peak area ratio was 81:19 and used as a positive electrode active material sample. FIG. 4 is a volume-based particle size frequency distribution chart of the primary particles of the positive electrode active material sample of example 2. Furthermore, FIG. 5 is a DTG curve of the positive electrode active material sample of example 2.

### Example 3

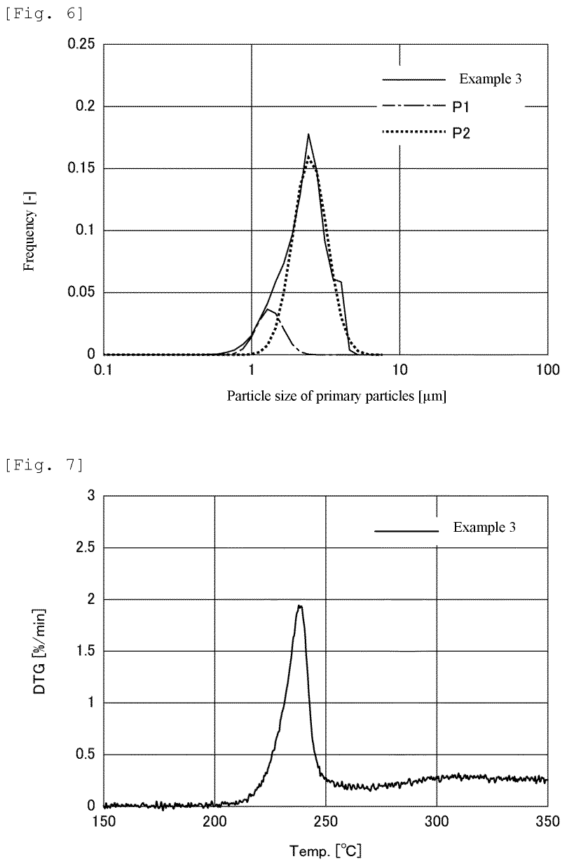

Composite oxide 2 alone was used as a positive electrode active material sample. FIG. 6 is a volume-based particle size frequency distribution chart of the primary particles of the positive electrode active material sample of example 3. Furthermore, FIG. 7 is a DTG curve of the positive electrode active material sample of example 3.

### Example 4

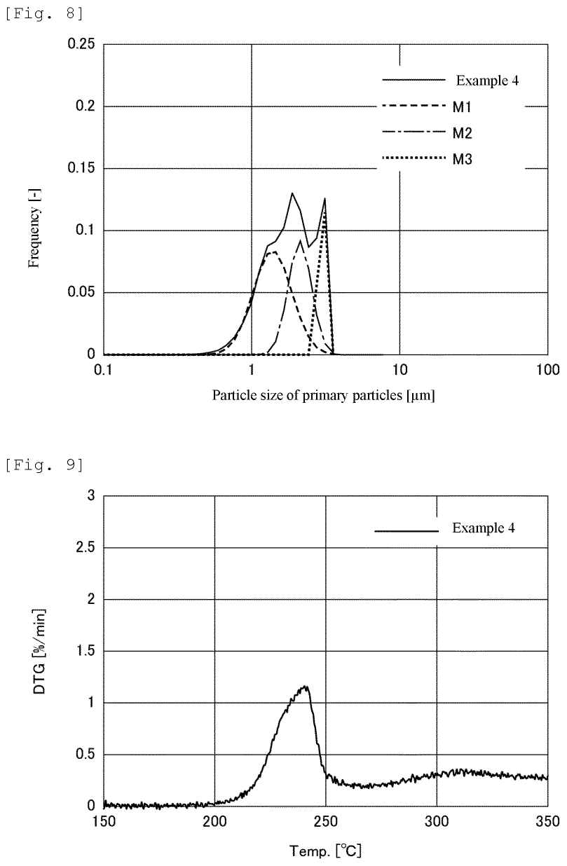

Composite oxide 3 alone was used as a positive electrode active material sample. FIG. 8 is a volume-based particle size frequency distribution chart of the primary particles of the positive electrode active material sample of example 4. Furthermore, FIG. 9 is a DTG curve of the positive electrode active material sample of example 4.

### Comparative Example 1

Composite oxide 1 alone was used as a positive electrode active material sample. FIG. 10 is a volume-based particle size frequency distribution chart of the primary particles of the positive electrode active material sample of comparative example 1. Furthermore, FIG. 11 is a DTG curve of the positive electrode active material sample of comparative example 1.

### <Evaluation>

The samples obtained were evaluated by the methods described below.

### [Compositional Analysis of Precursor Compound and Composite Oxide]

The compositions of the precursor composite compound and the positive electrode active material particles were determined by the following method. Samples of 0.2 g of the positive electrode active material were heated and dissolved in 25 mL of a 20% hydrochloric acid solution, and the materials were cooled then transferred to a 100 mL measuring flask, and pure water was introduced to prepare an adjusted liquid. The elements in the resulting adjusted liquid were quantitatively determined using ICP-AES (Optima 8300, produced by PerkinElmer, Inc.).

### [Mean Agglomerated Particle Size (D₅₀) of Precursor Compound]

This was measured on a volume basis by a wet laser method using a laser particle size distribution measurement apparatus (Microtrac HRA, produced by Nikkiso Co., Ltd.).

### [Scanning Electron Microscope Observation and Creation of Particle Size Frequency Distribution]

An electron microscope photograph observation was made for the positive electrode active material samples obtained, by using a field emission scanning electron microscope (JSM-7100F: produced by JEOL Ltd.) with an acceleration voltage of 10 kV and a magnification of 3000-20,000 times. Specifically, one field of view in which at least 100 primary particles for which the particle outline could be confirmed were visible was randomly selected, and an electron microscope photograph was obtained while varying the magnification within the abovementioned range, as required, for all of the particles for which the outline could be confirmed from among the particles included in that field of view. A sphere-equivalent diameter was calculated from the electron microscope photograph using image processing software (e.g., ImageJ, etc.), and this served as the particle size of the primary particles.

A kernel density distribution (number-based) employing a standard normal distribution as a kernel function was calculated from the data of the particle sizes of the primary particles obtained. After this, the primary particles were sphere-approximated and the volume-based particle size frequency distribution was obtained from the number-based distribution. It should be noted that in the volume-based particle size frequency distribution, the logarithm of the particle size is used as the horizontal axis. Furthermore, the reliability of the bandwidth parameter h relating to the distribution was determined with reference to Silverman's bandwidth (Silverman, B. W.: Density Estimation for Statistics and Data Analysis. Chapman & Hall, London-New York 1986, 175). The volume-based particle size frequency distribution obtained in this way was then fitted using a logarithmic normal distribution function and separated into peaks, to thereby calculate the particle size at the peak top of each of the peaks (central particle size of primary particles) and peak areas of the respective peaks.

It should be noted that if peaks that did not satisfy specific peaks (peaks of less than 0.1 in terms of area ratio with respect to the area of the main peak) were apparent when the peaks were separated, those peaks were deemed not to be peaks and were ignored, then the peaks were again separated. For example, P1 in example 2 was ignored as it was a peak that did not satisfy specific peaks.

### [Thermogravimetry Differential Thermal Analysis]

In order to confirm oxygen release behavior of the positive electrode active material samples, thermogravimetry differential thermal analysis (TG-DTA) was performed by using a thermogravimetry differential thermal analysis apparatus (DTG-60H, produced by Shimadzu Corp.).

### (Sample Preparation)

A 2032 type coin cell employing lithium as a counter electrode was prepared in accordance with the method described below, and after constant current charging to 4.30 V at 0.3 C under an environment of 25° C., constant voltage charging was performed until a current value of 0.05 C was reached. After this, there was a pause of 20 minutes following the completion of charging, constant current discharging at 0.3 C was performed to 2.50 V, after which constant current discharging was performed at 0.1 C, then there was a pause of 20 minutes. This charging and discharging were repeated twice. After constant current charging to 4.30 V at 0.3 C, constant voltage charging was then performed until a current value of 0.05 C was reached, and there was a pause of 20 minutes after the completion of charging.

The coin cell in a state of charge was disassembled inside a glove box (dew point:−70° C. or less) so that short-circuiting did not occur, and the positive electrode was collected. The collected positive electrode was washed for 10 minutes in DMC and dried under a vacuum inside a side box. After this, a positive electrode compound material was scraped from an Al foil using a spatula inside the same glove box. A TG measurement vessel made of Al was filled with 15 mg of a powder of the positive electrode compound material obtained, then covered with a lid and hermetically sealed using a crimping machine.

The Al measurement vessel obtained in this way was removed from the glove box and left to stand on a measurement-side balance of the TG-DTA apparatus.

### (TG-DTA Measurement)

Reference: Pt vessel filled with 15-20 mg Al₂O₃
Maximum temperature: 600° C.
Temperature increase rate:
   (1) 25° C. (room temperature) to 50° C.: 1° C./min
   (2) 50° C. to 600° C.: 5° C./min
Measurement environment: N₂ gas atmosphere (200 mL/min)

Immediately before the measurement, small holes were formed in the lid of the hermetically sealed Al measurement vessel inside the TG-DTA apparatus which was under the N₂ gas atmosphere, after which the temperature increase was started.

Based on the results obtained, a DTG curve was produced in which the horizontal axis was temperature and the vertical axis was a time-differentiated value of a weight change (TG) (this value was dTG, meaning a weight reduction rate, corresponding to the oxygen release rate of the composite oxide), and the maximum weight reduction value rate among peaks apparent in the region of 150° C.-350° C. was taken as the maximum oxygen release rate (%/min).

### [Evaluation of Charge Capacity of Coin Cell Employing Positive Electrode Active Material Sample]

In the present specification, a 2032 type coin cell employing the positive electrode active material particles was produced by using a positive electrode, negative electrode and electrolytic solution produced by the following respective methods.

### (Positive Electrode)

Using acetylene black and graphite as the conductive agent at a weight ratio of acetylene black:graphite=1:1, and using polyvinylidene fluoride as the binder, the positive electrode active material, conductive agent and binder were blended to achieve a weight ratio of positive electrode active material:conductive agent:binder=90:6:4, and a mixture of these materials with N-methylpyrrolidone was coated on an aluminum foil. The coated aluminum foil was dried at 110° C. to prepare a sheet which was punched to a diameter of 15 mm and then rolled at 3 t/cm² to form a positive electrode.

### (Negative Electrode)

A lithium foil having a thickness of 500 μm punched to a diameter of 16 mm was used as the negative electrode.

### (Electrolytic Solution)

A mixed solvent of EC and DMC was prepared at a volume ratio of EC:DMC=1:2, and a solution obtained by mixing a 1 mol/L LiPF₆ electrolyte therewith was used as the electrolytic solution.

### (Separator)

A separator (Celgard #2400: produced by Celgard) punched to a diameter of 20 mm was used.

### (Measurement of Total Charge Capacity)

Using the coin cell produced by the method above, after constant current charging to 4.30 V at 0.3 C at 25° C., constant voltage charging was performed until a current value of 0.05 C was reached. After this, there was a pause of 20 minutes following the completion of charging, constant current discharging at 0.3 C was performed to 2.50 V, after which constant current discharging was performed at 0.1 C, then there was a pause of 20 minutes. This charging and discharging were repeated twice. After constant current charging to 4.30 V at 0.3 C, constant voltage charging was then performed until a current value of 0.05 C was reached. In this operation, the total charge capacity (mAh/g) was calculated in the following manner.

### First Charging/Discharging:

4.3 V at 0.3 C (constant voltage charging until 0.05 C was reached)
20 minute pause
discharging to 2.5 V at 0.3 C, then further discharging to 2.5 V at 0.1 C
20 minute pause

### Second Charging/Discharging:

4.3 V at 0.3 C (constant voltage charging until 0.05 C was reached)
20 minute pause
discharging to 2.5 V at 0.3 C, then further discharging to 2.5 V at 0.1 C

### Third Charging:

4.3 V at 0.3 C (constant voltage charging until 0.05 C was reached)

$$total charge capacity = first charge capacity + ( second charge capacity - first discharge capacity at 0.3 C . - first discharge capacity at 0.1 C . ) + ( third charge capacity - second discharge capacity at 0.3 C . - second discharge capacity at 0.1 C . )$$

The peak area ratio, area ratio of other specific peaks to the main peak, central particle size ratio of adjacent specific peaks, total charge/discharge capacity, DTG peak top temperature, maximum oxygen release rate, and rate of reduction in maximum oxygen release rate compared with comparative example 1 are shown in table 1 for the composite oxides constituting the samples of examples 1-4 and comparative example 1.

TABLE 1

| | | | | | | | | | Characteristics | | | |
|---|---|---|---|---|---|---|---|---|---|---|---|---|
| | | | | | | | Particle size frequency | | | | | Maximum |
| | | | | | | | distribution peaks | | | | | oxygen |
| | | | | | | | | Central | | DTG | Maxi- | release rate |
| | Central particle size of composite oxide and peak area ratio | | | | | | Area ratio | particle | Total | peak | mum | (reduction |
| | Composite | Composite | | Composite | | | of other | size ratio | charge | top | oxygen | rate) vs |
| Central | oxide 1 | oxide 2 | | oxide 3 | | | specific | of adjacent | capacity | temper- | release | Comparative |
| particle | L1 | P1 | P2 | M1 | M2 | M3 | peaks to | specific | [mAh/ | ature | rate | Example |
| size | 0.5 μm | 1.4 μm | 2.7 μm | 1.5 μm | 2.2 μm | 3.0 μm | main peak | peaks | g] | [° C.] | [%/min] | 1 [%] |
| Example 1 | 50.0% | 8.0% | 42.0% | — | — | — | 0.16 (P1/L1) | 2.80 (P1/L1) | 229 | 225 | 1.273 | 55 |
| | | | | | | | 0.84 (P2/L1) | 1.99 (P2/P1) | | | | |
| Example 2 | 81.0% | — | 19.0% | — | — | — | 0.24 (P2/L1) | 5.54 (P2/L1) | 230 | 226 | 1.918 | 83 |
| Example 3 | — | 15% | 85% | — | — | — | 0.18 (P1/P2) | 1.93 (P2/P1) | 231 | 238 | 1.942 | 84 |
| Example 4 | — | — | — | 50% | 33% | 17% | 0.66 (M2/M1) | 1.45 (M2/M1) | 225 | 240 | 1.162 | 50 |
| | | | | | | | 0.34 (M3/M1) | 1.36 (M3/M2) | | | | |
| Comparative | 100% | — | — | — | — | — | — | — | 231 | 225 | 2.306 | 100 |
| Example 1 | | | | | | | | | | | | |

It can be seen from the results in table 1 that, when there are a plurality of specific peaks and the central particle size ratios of the specific peaks are all within a predetermined range, it is possible to reduce the maximum oxygen release rate in relation to comparative example 1 which has only one specific peak.

1. A method of using a positive electrode active material comprising a composite oxide that contains at least lithium, a transition metal, and oxygen, wherein:
when a volume-based particle size frequency distribution of primary particles of the composite oxide is separated into a plurality of peaks, these peaks include specific peaks comprising:
a main peak exhibiting a maximum value of peak area, and at least one peak having an area in a range of from 0.1 to 1, in terms of area ratio, with respect to the area of the main peak, and
ratios of primary particle size (large particle size/small particle size) at peak tops of adjacent specific peaks are all in a range of from 1.2 to 8;
the method comprising using the positive electrode active material to inhibit or avoid thermal runaway in a nonaqueous electrolyte secondary battery.

2. The method of using the positive electrode active material as claimed in claim 1, the method comprising using the positive electrode active material to control the oxygen release from the positive electrode active material.

3. The method of using the positive electrode active material as claimed claim 1, wherein the composite oxide is a lithium-nickel composite oxide.

4. The method of using the positive electrode active material as claimed in claim 3, wherein the lithium-nickel composite oxide has a layered rock-salt structure and is represented by the general formula LiₐNi_{1-b-c}Mn_{b}M_{c}O₂, wherein M is one or more elements other than Li, Ni, Mn, and O, and wherein 0.95≤a≤1.15, and 0≤b+c≤0.70.

5. The method of using the positive electrode active material as claimed in claim 4, wherein M is selected from the group consisting of one or more of Co, Al, Mn, Ti, Mg, Zn, Nb, W, Mo, Sb, V, Cr, Ca, Fe, Ga, Sr, Y, Ru, In, Sn, Ta, Bi, Zr and B.

6. The method of using the positive electrode active material as claimed in claim 5, wherein M is Co or both Co and Al.

7. The method of using the positive electrode active material as claimed in claim 6, wherein M is both Co and Al.

8. The method of using the positive electrode active material as claimed in claim 4, wherein the lithium-nickel composite oxide has the formula LiₐNi_{1-b-c1-c2}Mn_{b}Co_{c1}Al_{c2}O₂, where and wherein 0.95≤a≤1.15, 0.75≤[1−b−c1−c2]<0.90; 0.01≤b≤0.10; 0.05≤c1≤0.20; and 0≤c2≤0.05.

9. The method of using the positive electrode active material as claimed in claim 1, wherein the primary particle sizes at peak tops of the specific peaks are all in a range of from 80 nm to 15 μm.

10. A positive electrode active material for a nonaqueous electrolyte secondary battery, the positive electrode active material comprising a composite oxide that contains at least lithium, a transition metal, and oxygen, wherein:
when a volume-based particle size frequency distribution of primary particles of the composite oxide is separated into a plurality of peaks, these peaks include specific peaks comprising:
a main peak exhibiting a maximum value of peak area, and at least one peak having an area in a range of from 0.1 to 1, in terms of area ratio, with respect to the area of the main peak, and
ratios of primary particle size (large particle size/small particle size) at peak tops of adjacent specific peaks are all in a range of from 1.2 to 8.

11. The positive electrode active material for a nonaqueous electrolyte secondary battery as claimed in claim 10, wherein the composite oxide is a lithium-nickel composite oxide which has a layered rock-salt structure and is represented by the general formula LiₐNi_{1-b-c}Mn_{b}M_{c}O₂ fin the formula, wherein M is at least one element other than Li, Ni, Mn and 0, 0.95≤a≤1.15, and 0≤b+c≤0.70).

12. The positive electrode active material for a nonaqueous electrolyte secondary battery as claimed in claim 11, wherein M is selected from the group consisting of one or more of Co, Al, Mn, Ti, Mg, Zn, Nb, W, Mo, Sb, V, Cr, Ca, Fe, Ga, Sr, Y, Ru, In, Sn, Ta, Bi, Zr and B.

13. The positive electrode active material for a nonaqueous electrolyte secondary battery as claimed in claim 12, wherein M is Co or both Co and Al.

14. The positive electrode active material for a nonaqueous electrolyte secondary battery as claimed in claim 13, wherein M is both Co and Al.

15. The positive electrode active material for a nonaqueous electrolyte secondary battery as claimed in claim 10, wherein the lithium-nickel composite oxide has the formula LiₐNi_{1-b-c1-c2}Mn_{b}Co_{c1}Al_{c2}O₂, where and wherein 0.95≤a≤1.15, 0.75≤[1−b−c1−c2]≤0.90; 0.01≤b≤0.10; 0.05≤c1≤0.20; and 0≤c2≤0.05.

16. The positive electrode active material for a nonaqueous electrolyte secondary battery as claimed in claim 10, wherein the primary particle sizes at peak tops of the specific peaks are all in a range of from 80 nm to 15 μm.

17. A nonaqueous electrolyte secondary battery comprising a positive electrode containing the positive electrode active material as claimed in claim 10.
